(19) United States
(12) Patent Application Publication
(10) Pub. No.: US 2008/0005257 A1
(43) Pub. Date: Jan. 3, 2008

(54) DUAL PROCESSOR BASED DIGITAL MEDIA PLAYER ARCHITECTURE WITH NETWORK SUPPORT

(75) Inventors: Jason D. Carnahan, Boise, ID (US); Steven T. Baker, Salt Lake City, UT (US); Benjamin A. Kendall, Boise, ID (US)

Correspondence Address: WORKMAN NYDEGGER, 60 EAST SOUTH TEMPLE, 1000 EAGLE GATE TOWER, SALT LAKE CITY, UT, 84111, US

(73) Assignee: KESTRELINK CORPORATION, Boise, ID (US)

(21) Appl. No.: 11/427,496

(22) Filed: Jun. 29, 2006

(51) Int. Cl. G06F 15/167

(52) U.S. Cl. 709/212

(57) ABSTRACT

A system for accessing data across a network. The system includes a first processor configured to consume data. A second processor is connected to the first processor via a physical media storage interface. As such, the first processor interfaces with the second processor as if the second processor were a physical media storage device. The second processor is connectable via a network interface to a physical media storage device so as to be able to provide data from the physical media storage device to the first processor. The system includes a computer readable medium including computer executable instructions configured to compensate for at least one of time latencies or network connection problems caused by the network interface between the second processor and the physical media storage device.

### BACKGROUND

### Background and Relevant Art

Computers and computing systems have affected nearly every aspect of modern living. Computers are generally involved in work, recreation, healthcare, transportation, entertainment, household management, etc. As computers become more widely used, digital data also becomes more prevalent and more desirable. For example, digital data can be used to represent audio and video signals. Music on CDs is stored digitally. Audio and video on DVDs is also stored digitally. Television signals provided over cable and satellite systems are generally provided in a digital format. In many areas, digitally encoded television signals can even be received from traditional over the air (OTA) broadcasters that have previously only broadcast analog signals.

Because this data can be stored digitally, individuals have begun using media servers where audio, video, and image data is stored on a computer system, central server or other central storage. This allows the user to have a repository of multimedia data. The user can then play or display the multimedia data directly from the computer, or send the data over the network to another computer or multimedia player through a network connection.

Home networks are a fairly recent innovation, and as such, generally only the newest homes have network cabling installed. Even many new homes do not have network cable installed during construction. Thus, individuals who wish to implement a home network often implement the home network using wireless routers so as to avoid expensive cabling retrofits. Wireless networks generally have lower data bandwidth capacities as compared to wired networks. For example, nearly all wired network are rated at 100 megabits per second (Mbs) and many are rated at 10 times that, namely 1 gigabit per second (Gbs). Common standardized wireless networks are limited to 54 Mbs, with some as high as 108 Mbs. The actual performance of wireless networks can be seriously degraded by interference from other wireless networks, cellular communications, microwave radiation, cordless telephones, etc.

Media applications, and in particular video applications, often require high bandwidths to transmit data. For example, video at DVD quality resolution requires about 8 Mbs of consistent bandwidth for just the media alone exclusive of network protocol messages needed to transport the data across a TCP/IP network. High definition television (HDTV) signals often require about 20 Mbs and may require up to 80 Mbs to transmit a transport stream with multiple channels. Disruptions in wireless networks may result in poor playback of media files, or the inability to transfer media requiring high bandwidths.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment describes a system for accessing data across a network. The system includes a first processor configured to consume data. A second processor is connected to the first processor via a physical media storage interface. As such, the first processor interfaces with the second processor as if the second processor were a physical media storage device. The second processor is connectable via a network interface to a physical media storage device so as to be able to provide data from the physical media storage device to the first processor. The system includes a computer readable medium including computer executable instructions configured to compensate for at least one of time latencies or network connection problems caused by the network interface between the second processor and the physical media storage device.

Embodiments may include methods for accessing data across a network. In one embodiment, such a method includes receiving at a first processor, data from a second processor. The data is received from the second processor across a physical media storage interface. The second processor retrieves the data across a network interface from a physical media storage device. The method further includes compensating for at least one of time latencies or network connection problems caused by the network interface between the second processor and the physical media storage device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an overview of a system for delivering media content to users; and

FIG. 2 illustrates a block-diagram of a media player.

### DETAILED DESCRIPTION

Embodiments herein may comprise a special purpose or general-purpose computer including various computer hardware, as discussed in greater detail below.

One embodiment described herein uses a dual processor system, where the dual processors are interconnected via an interface intended for connection to storage devices such as an IDE interface. IDE interfaces are typically used for storage communication as apposed to processor interconnection. A system may include a specialized media decoder processor which includes specialized hardware for decoding and displaying media data, such as audio, video and/or image data. The decoder processor may be connected via an IDE interface, or other storage based connection, to a network processor that includes functionality for sending and receiving data across a network. By connecting the network processor to the decoder processor through an IDE interface, the network processor can be treated by the decoder processor as an IDE storage device. An emulator can be used to convert storage operations to network operations and vice versa.

The network processor includes an interface for connecting to a network where data can be obtained. For example, the network processor may connect to a server which includes physical storage for storing data. To obtain video or other data, the video decoder processor may send storage device protocol messages across the IDE interface and to the network processor. Typically, the media data is accessed through DMA (direct memory access) data access, while other data such as FAT table data, FAT directory information and the like is accessed manually through software controlled hard drive read commands. This is done in a transparent fashion such that the decoder processor treats the network processor as a storage device. The network processor can then obtain data from a server across a network and provide the data to the decoder processor in a fashion similar to how a storage device provides data across an IDE interface. Because data is being obtained by the network processor across a network, network delays may be introduced into the architecture.

Typically, when implementing an IDE interface, it is assumed that the storage device is local to the processor accessing the storage device and that communications take place fairly quickly. However, the network delays described above may result in various difficulties. For example, one particular method of accessing data across an IDE interface involves sending a DMA request. DMA requests allow data to be retrieved through DMA hardware to avoid burdening the central processing unit. To avoid corruption of data and other difficulties, only a single DMA request should be active at any particular time. When a physical storage device is in near proximity to the processor consuming data from the storage device, there is usually little difficulty due to the speed of the connection between the processor and storage device. Specifically, by the time a following DMA request is made, a previous DMA request will always be completed. However, when network delays are introduced, there may be some difficulty in that longer than expected latencies may exist between the time when a DMA request is issued and when the corresponding data is returned. To counteract these timing difficulties, various techniques are used, including various delays, cancellations of DMA operations, error reporting, streaming file position maintenance, and redundant file characteristic determination.

An additional difficulty not expected by IDE storage busses relates to conditions when no responses are received. When a processor is connected to an IDE device over a network, loss of network connectivity or loss of network devices or services may result in a condition where there is no response whatsoever from a DMA request or other IDE request. For example, if a network service is instantiated and later shut-down, a DMA request may be issued for retrieving data from the network service where no response will be received because the service is not able to send a response of any kind.

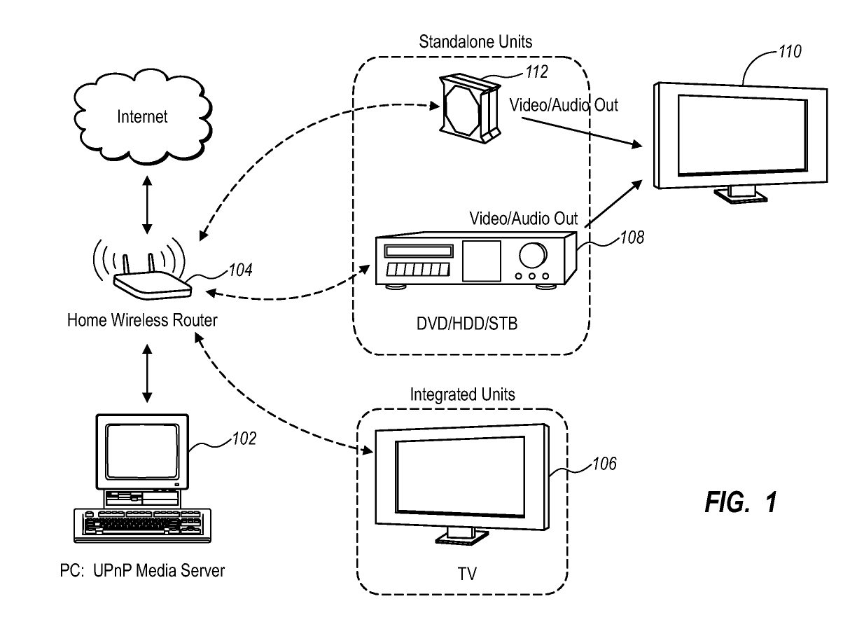

Referring now to FIG. 1, an exemplary environment where some embodiments of the invention may be practiced is illustrated. FIG. 1 illustrates a media server 102, which in this example is a universal plug and play (UPnP) server. The media server 102 may store various media files such as music files, video files, and picture files. Generally, the media server 102 is located in a local area network (LAN) and configured to provide the media files locally to clients. For example, in one embodiment, the media server 102 may be implemented in a home environment to provide media to home users.

The media server 102 is connected through a router 104 to various clients in the network. The clients on the network may include specialized media adapters configured to provide media to users. As will be discussed further herein, the media adapters may include specialized hardware optimized for providing the media to users. For example, the media adapters may include processors that are optimized for decoding compressed audio, video or image data. The media adaptors may be embodied in a number of forms as illustrated in FIG. 1. For example, FIG. 1 illustrates an integrated media adapter integrated into a television 106. With this configuration, there is no need for an external box including the media adapter because the media adapter is integrated into the television where the media will be displayed or played.

FIG. 1 also illustrates a number of standalone units. For example, the media adapter may be integrated into a DVD player 108. This embodiment is particularly interesting as often the encoding typical on DVDs is the same as the encoding for stored video files or over the air (OTA) transport streams. Thus, the specialized hardware can be used both for decoding DVD signals as well as decoding data streamed from the media server 102 to the media adapter in the DVD player 108. The DVD player 108 is connected through audio and video connections to a television 110 where the DVD video can be played or where the media data from the media server 102 can be displayed.

FIG. 1 further illustrates a self contained media adapter 112. The self contained media adapter 112 includes the specialized hardware for decoding and displaying media streamed from the media server 102. The self contained media adapter 112 is connected to the television 110 through audio and video connections.

Each of the examples of media adapters whether embodied in an integrated unit such as with the television 106, or a standalone unit such as the DVD player 108 or self contained media adapter 112, or other media adapter is connected, in this example, through the router 104 to the media server 102. The connections between the media server 102, router 104 and media adapters may be any suitable network connection including hardwired Ethernet connections, wireless wi-fi connections, or any other suitable connection. Notably some embodiments described herein optimize wireless network connections to maintain suitability for transmitting high bit rate media files.

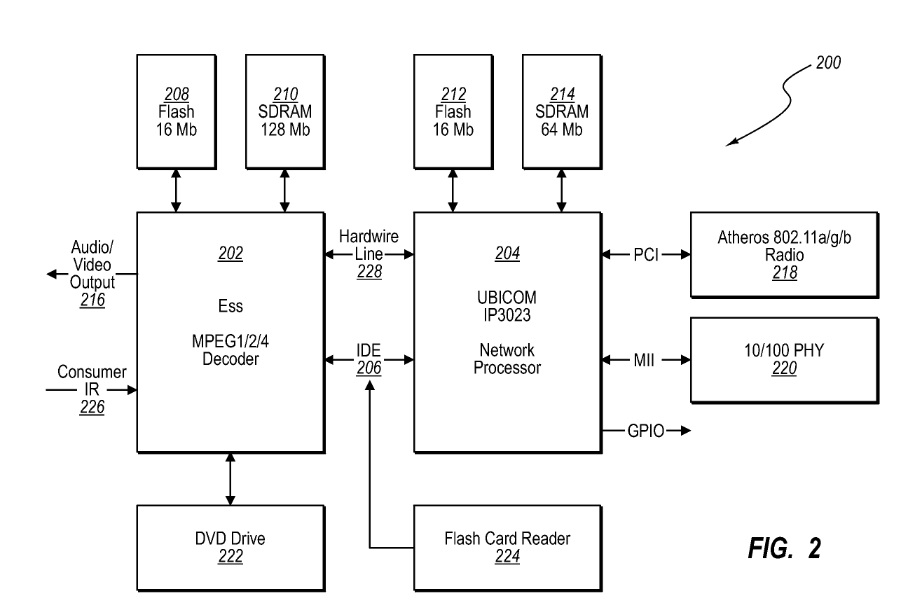

Referring now to FIG. 2, hardware from the media adapter is illustrated. As described previously, the media adapter 200 includes two processors coupled by an IDE bus. While an IDE bus is illustrated here, other storage device type busses may also be used. The media adapter 200 includes an mpeg decoder processor 202 coupled to a network processor 204 through an IDE bus 206. Each of the processors 202, 204 includes other appropriate peripheral hardware. For example, the decoder processor 202 is coupled to flash memory 208 and DRAM memory 210. The flash memory and DRAM memory 210 may store computer executable instructions such as computer applications to be executed on the decoder processor 202. Additionally, the DRAM memory 210 may store data from the network processor 204, such as audio, video, or image data. The data stored in the DRAM memory 210 can be displayed by sending audio and video signals through the audio video output line 216. Notably, the audio video output line 216 may be any one of a number of formats including various combinations of composite, component video, HDMI, DVI, etc.

Similar to the decoder processor 202, the network processor 204 has a flash memory 212 and a DRAM memory 214 connected to it. The flash memory 212 and DRAM memory 214 are computer readable media that may include computer executable instructions that can be executed by the network processor 204. In addition, the DRAM memory 214 may store data for delivery to the decoder processor 202. For example, the network processor 204 may receive data from a data store such as a media server, such as the media server 102. This data may be stored in the DRAM memory 214 for delivery to the decoder processor 202. Such data may include for example, media, file information, directory information, or other information. In the example illustrated, the network processor 204 may be connected to a media server through one or more different network connections.

FIG. 2 illustrates both wired and wireless connections. For example, the network processor may be connected through a PCI bus connection to a wireless radio 218. In this example, the wireless radio 218 supports IEEE 802.11a, b, and g wireless signals. IEEE 802.11a and g may be advantageous for video transmission as they are able to handle media streams at higher bit rates than IEEE 802.11b transmissions. The wireless radio 218 may communicate with a wireless router, such as the router 104 shown in FIG. 1. The wireless router 104 can then communicate with the media server 102, either wired or wirelessly, for completing the connection between the network processor 204 and the media server 102.

FIG. 2 further illustrates that the network processor 204 may communicate with the media server through a wired connection such as by using a standard 10/100 Mbs (megabits per second) Ethernet adapter 220. Similar to the wireless example, the Ethernet adapter 220 may be connected to the router 104, which is in turn connected to the media server 102. While in this example a 10/100 Mbs adapter is used, it should be appreciated that Gigabit Ethernet adapters, or any other suitable adapter, whether wired or wireless, may be used.

FIG. 2 illustrates two additional options. The first is a DVD drive 222 connected to the decoder processor 202. As explained previously, often the encoding on DVDs is the same as the encoding for other video and audio files. As such, the specialized hardware on the decoder processor 202 is especially suited for decoding DVD video. As such, a more functional device may be implemented where the device includes a DVD drive 222 such that DVD video can be played from the device. Such a device is illustrated in FIG. 1 at 108.

FIG. 2 illustrates a second option, which includes a flash card reader 224 connected to the decoder processor 202 through the IDE bus 206. This option allows users to display media from a portable flash card using the media adapter 200. For example, flash cards from digital cameras or camcorders can be plugged directly into the flash card reader 224 obviating the need to store the media on the media server 102 prior to viewing the media using the media adapter 200. One or more alternatives for the flash card reader 224 may be provided. For example, the flash card reader 224 may have provisions for compact flash, secure digital, multimedia, etc. Additionally, in one embodiment, the flash card reader 224 may include a USB interface for connecting directly to a USB flash storage device or USB connectable hard-disk drive.

It is useful to notice at this point that the media player is unique in that the two processors, the decoder processor 202 and network processor 204 are connected through an IDE bus 206. This is particularly interesting in light of the fact that ordinarily such communications would take place on a PCI or other type of communication bus. Typically, an IDE bus is used for connecting storage to a processor. However, by using an IDE bus 206 to connect to the decoder processor 202 and network processor 204, several advantages can be realized. For example, typical decoder processors come equipped with a standard IDE bus interface for connecting storage to the decoder processor. However, some decoder processors may not come equipped with network connectivity, and as such may not be suitable on their own for use in a media adapter connectable in a network. By using the IDE bus interface to connect through an IDE bus to a network processor, networking functionality can be added to virtually any media decoder processor.

Additionally, this configuration allows for a smaller operating system, selection of a specialized network processor, easy replacement of the network processor in subsequent designs when additional networking speeds and as functionality become available, easy replacement of the decoder processor in subsequent designs, reduced memory requirements, etc.

Ordinarily, a storage device connected to a host processor through an IDE bus is somewhat passive in nature. In other words, typically the IDE device accepts commands from the host processor, and can be polled by the host processor for information, but does not typically provide data to the host processor without first being prompted. In the example shown in FIG. 2, the decoder processor 202 assumes the role of the host processor and the network processor 204 assumes the role of the device in the IDE connection. To facilitate the network processor 204 providing information to the decoder processor 202, a hardware line 228 connects the two processors. If the network processor 204 has information to pass to the decoder processor 202, the network processor 204 can set the line signaling to the decoder processor 202 that the network processor 204 has information to pass to the decoder processor 202. The decoder processor 202 can then poll the information from the network processor 204. Such information may include, among other things, diagnostic information.

For example, the network processor 204 may be able to detect various conditions such as a storage device not being connected to one of the network connections 218, 220, or the inoperability of the network. The network processor 204 can thus signal on the hardware line 228 that it has data for the decoder processor. When the decoder processor 202 polls the network processor 204, the network processor 204 can provide the diagnostic information.

The use of the IDE bus for connecting to a network processor which retrieves the content to be decoded from a network store is not without drawbacks. In particular, IDE connections typically have small latencies from when data is requested to when the data is returned. However, network connections are unreliable and can have longer latencies, or in worst case scenarios, resources are not available, due to network congestion, network machine configuration, network server power state, or other networking problems. Wireless Wi-Fi networks in particular are susceptible to RF interference generated by common household appliances such as microwave ovens and cordless phones. As such, IDE interfaces typically do not have error handling capabilities for long latencies. However, some embodiments described herein address these latency mismatches.

Some issues relate to DMA requests. As noted above, typically media data, such as video, audio and image data, is retrieved from the network processor 204 through DMA requests. DMA is a communication mechanism where messages can be sent within a computer system without the messages being passed through the CPU of the computer system. This allows for faster communication, as the CPU does not need to process data sent on the DMA channels to facilitate the transfer of the data. Thus, a state machine in the computer system is used to transfer data. Data may also be transferred manually in a computer system. This involves accessing data by using software computer executable instructions executed by the processor to access the data. As noted previously, file and directory information is generally transferred using manual hard drive access. For example, software executed by the CPU in the decoder processor 202 may cause a hard drive read of a specified number of bytes from the network processor 204.

Generally, media data is transferred by using DMA requests. When the DMA state machine senses that the DMA state machine is idle, the DMA state machine will send additional requests. However, when long latencies exist due to slower network transfers, the DMA state machine may sense that the DMA state machine is idle, when in fact the DMA state machine is waiting for a previous DMA request to be serviced. For example in one embodiment, when using trick modes, e.g. fast-forward and rewind, there may be issues with one DMA request being issued before a previous DMA request has been serviced. Specifically, a trick mode command received from a user through an IR interface 226 (FIG. 2) such as a remote control, or other user interface may cause a new DMA request to be issued while a previous DMA request is currently being serviced. This may result in loss of data for both transactions.

To overcome this difficulty, some embodiments include using an IDE sectors left to read indication to delay invoking of subsequent DMA requests. For example, the DMA state machine in the decoder processor may include or have access to an ide_sectors_to_read register which stores an indicator of how many sectors of data need to be read to complete the current read operation. Thus, in one embodiment trick mode operations do not begin until the ide_sectors_to_read register reaches 0. To prevent subsequent DMAs, a mutex may be used to lock the DMA state machine.

Typically DMA state machines and IDE bus protocols do not include time-out provisions. However, as explained previously, using an IDE bus to access data that is stored across a network may result in some delays not typically anticipated by DMA state machines or other storage based hardware and software. Thus, one embodiment includes provisions for implementing a time-out. The time-out may be used to cancel DMA operations. Embodiments may also include provisions for resetting DMA hardware, such as a DMA state machine. Additionally, embodiments may include provisions for halting further DMA operations. Further still, embodiments may include provisions for signaling to a central processing unit that data read requests should be suspended. Notably, various embodiments have different time-out periods. For example, embodiments implemented on wireless networks may have longer time-out periods than embodiments implemented on wired networks. Additionally, embodiments implemented on faster wireless network such as 802.11a or g networks may be shorter time-out periods than embodiments implemented on slower wireless networks such as 802.11b networks.

Referring once again to FIG. 2, the particular decoder processor 202 shown is an MPEG1/2/4 decoder may be implemented for example using part numbers ES6425FF, ES8381FCD, or ES6430FAA available from ESS Technology, Inc. located in Fremont Calif. These particular decoders include various hardware components including a central processing unit, a DMA state machine, an interrupt state machine and a media player state machine. The central processing unit coordinates interactions between the different state machines and generally manages data flow and decoding activities. The DMA state machine manages DMA data requests to perform DMA data handling. The interrupt state machine generally includes a number of registers and indicators indicating active interrupts for obtaining service from the central processing unit from other components including components included in the decoder processor 202. The media player state machine includes functionality for controlling how media is accessed and played for a user. For example, the media player state machine may include functionality for implementing play, pause, fast-forward, rewind, etc. This can be used to control what data is requested, and when the data is requested.

In one embodiment, while streaming a file, a DMA read operation may exceed a predetermined time from when a command for the DMA read operation to begin is issued. This can be determined by monitoring for an IDE interrupt to be triggered when data is available to read and/or a DMA request status indicating that a read is complete. If these indicators do not indicate within a predetermined time that data is available and/or that a read is complete, time-out operations can be performed.

In one embodiment, the time-out operations may include provisions for signaling various components of the decoder processor 202 to cease file access activities. For example, a command may be invoked to disable IDE interrupts sent to the central processing unit of the decoder processor 202. Additionally, a command may be invoked to clear any interrupts in an interrupt controller included in the decoder processor 202 to stop any possible interrupts. Commands may also be invoked to set values of registers available to the central processing unit indicating that no IDE interrupts are set, no IDE sectors are available to read, and that the IDE is in an idle state meaning that there are no active reads. Additionally, to prevent further IDE reads from taking place for accessing additional data, the media player state machine may be given a command appropriate to prevent the media player state machine from causing additional data to be requested. For example, the media player state machine may be given a pause or stop command to prevent additional media data from being requested for displaying to a user. Notably, a pause command may be advantageous if some recovery processes are to be performed such that media can be played starting at the location where the time-out occurred. The stop command may be advantageous if restarting from the location when the time-out occurred is not possible, practical, and/or desirable.

Another issue that is addressed by some embodiments relates to manual IDE reads. For example, when a user browses files, such as by browsing file information, images, video, music, media content, directories and the like, manual read commands are used to set up the network processor and verify that the file actually available to process. These may be used, as explained above to read FAT tables or directory information. As with the DMA example, the manual reads may take too much time or time-out. This may be determined in a fashion similar to the DMA time-out in that the IDE interrupt may take too long to go off, and/or the DRQ request status, indicating that all data has been read, may not be set. Thus, some embodiments include functionality for propagating errors back to calling functions so that the calling function knows that it did not receive the correct amount of data.

Embodiments facilitate propagating timeout information to various portions of the system. Thus, time-out activities can be processed by the media player state machine, the DMA state machine, software routines being run by the CPU in the decoder processor 202, etc.

One embodiment described herein further includes functionality for file type detection including a redundant file type check. Some decoder processors include functionality for detecting file type and bitrate. For example, a decoder processor may include a routine in the firmware of the decoder processor for detecting that a file is an MPEG2 file with a bitrate of 8 Mbs. However, typically the decoder processor expects the file to be quickly accessible through an IDE bus interface. However, when the file is delayed in its transfer to the decoder processor because of network delays, the file type and bitrate detection of the decoder processor may not function appropriately, and erroneous file types and bitrates may be detected. Thus, one embodiment includes functionality for including a redundant file type and bitrate detection algorithm which can take into account the network delays such that the appropriate bitrate and file type may be detected and displayed to a user by the decoder processor 202.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a system for accessing data across a network, the system comprising:
a first processor configured to consume data;
a second processor coupled to the first processor via a physical media storage interface such that the first processor interfaces with the second processor as if the second processor were a physical media storage device, and wherein the second processor is connectable via a network interface to a physical media storage device so as to be able to provide data from the physical media storage device to the first processor; and
a computer readable medium comprising computer executable instructions configured to compensate for at least one of time latencies or network connection problems caused by the network interface between the second processor and the physical media storage device.

2. The system of claim 1 wherein the first processor comprises a media decoder processor for decoding compressed video files.

3. The system of claim 1 wherein the computer executable instructions are configured to correlate DMA requests to prevent multiple DMAs from being requested at a given time.

4. The system of claim 1 wherein the computer executable instructions implement a wait corresponding to a number of IDE sectors left to read as dictated by an IDE sectors to read count variable.

5. The system of claim 4 wherein the wait implements a mutex to lock DMA resources from being used while a first DMA is active to prevent a simultaneous second DMA.

6. The system of claim 1 wherein the computer executable instructions implement a time-out and cancellation of a first DMA request to allow a subsequent DMA request to be issued without conflicting with the first DMA request.

7. The system of claim 1 further wherein the computer executable instructions are configured to reset a file position when DMA requests, associated with a trick mode, time-out.

8. The system of claim 1 further wherein the second processor is coupled to the first processor with a hardware line to indicate to the first processor that the second processor has diagnostic data to pass to the first processor.

9. The system of claim 1 further wherein the network interface comprises a wireless network interface.

10. The system of claim 1 further wherein the network interface comprises a wired network interface.

11. The system of claim 1 wherein the physical media storage interface comprises an IDE bus.

12. The system of claim 1 wherein the computer executable instructions are configured to issue a pause or stop trick mode command to a trick mode state machine.

13. The system of claim 1 wherein the computer executable instructions are configured to reset DMA interrupts.

14. The system of claim 1 wherein the computer executable instructions are configured to disable DMA interrupts.

15. The system of claim 1 wherein the computer executable instructions comprises computer executable instructions for performing a file type and bitrate check that accounts for IDE bus delays.

16. In a computing environment, a method for accessing data across a network, the method comprising:
receiving at a first processor, data from a second processor, wherein the data is received from the second processor across a physical media storage interface, further wherein the second processor retrieves the data across a network interface from a physical media storage device; and
compensating for at least one of time latencies or network connection problems caused by the network interface between the second processor and the physical media storage device.

17. The method of claim 16, wherein compensating for at least one of time latencies or network connection problems caused by the network interface between the second processor and the physical media storage device multiple DMAs from being requested at a given time comprises implementing a wait corresponding to a number of sectors left to read as dictated by a sectors to read count variable.

18. The method of claim 16, wherein compensating for at least one of time latencies or network connection problems caused by the network interface between the second processor and the physical media storage device comprises preventing multiple DMAs from being requested at a given time

19. The method of claim 16, wherein compensating for at least one of time latencies or network connection problems caused by the network interface between the second processor and the physical media storage device comprises implementing a time-out and cancellation of a first DMA request to allow a subsequent DMA request to be issued without conflicting with the first DMA request.

20. In a computing environment, a method for providing data from a network connected physical media storage device, the method comprising:
at a first processor, receiving data from the physical media storage device across the network;
providing the data received from the physical media storage device to a second processor across a physical media storage interface; and
compensating for at least one of time latencies or network connection problems caused by a network interface between the first processor and the physical media storage device.
